(19) United States
(12) Patent Application Publication
(10) Pub. No.: US 2014/0227400 A1
(43) Pub. Date: Aug. 14, 2014

(54) BREATHABLE CONTAINER SEAL

(71) Applicant: Fazal Imam Farooqui, Maharashtra (IN)

(72) Inventor: Fazal Imam Farooqui, Maharashtra (IN)

(73) Assignee: H.J. HEINZ COMPANY, Pittsburgh, PA (US)

(21) Appl. No.: 14/237,722

(22) PCT Filed: Mar. 14, 2013
(86) PCT No.: PCT/US2013/031434

§ 371 Date: Feb. 7, 2014

Related U.S. Application Data
(60) Provisional application No. 61/755,690, filed on Jan. 23, 2013.

(51) Int. Cl. B65D 53/00; B65D 51/16; B32B 15/12; B23K 26/40

(52) U.S. Cl. CPC B65D 53/00; B23K 26/409; B65D 51/1611; B32B 15/12
USPC 426/126; 219/121.71; 220/745; 428/137

(57) ABSTRACT

A multi-layer seal material comprising a layer of paper or pulp, next to a layer of polymer, next to a layer of metal foil, next to a layer of adhesive polymer, the seal containing micro-holes allowing the seal to be breathable. A method of making a sealed container is also described by forming the multi-layer seal material described above, using laser drilling to generate the micro-holes in the seal material, placing the adhesive polymer layer of the multi-layer seal material onto a container filled with product material, heating the seal material to bond the seal to the container, thereby forming a product filled container having a breathable seal.

### CROSS-REFERENCE TO RELATED APPLICATIONS

The instant application is a PCT International Application claiming the benefit of priority of U.S. provisional application No. 61/755,690, filed Jan. 23, 2013, the disclosure of which is hereby expressly incorporated by reference hereto in its entirety.

### BACKGROUND OF THE INVENTION

1. Field of the Invention

The invention generally pertains to a packaging seal material comprising a plurality of layers or surfaces, adhered or cohered to each other.

2. Discussion of Background Information

In the packaging area, the various requirements for the material used depends heavily on what is to be contained. In addition to the shipping and handling considerations, the appearance and condition of the product for ultimate use by the consumer is an important consideration as well. Added on top of these considerations is cost and availability of materials, ease of processing and handling of materials, and the manufacturing process in general. Accordingly, the determination of packaging materials for a particular use can present a very complex challenge.

The present invention meets all of the challenges described above, with the addition of accommodating a product which requires breathability but must remain food-safe as well.

### SUMMARY OF THE INVENTION

A multi-layer seal material is described made up of a layer of paper or pulp, next to a layer of polymer, next to a layer of metal foil, next to a layer of adhesive polymer, the seal material containing micro-holes allowing the seal to be breathable.

A method of making a sealed container is also described, by forming a multi-layer seal material comprising a paper or pulp layer next to a polymer layer, next to a layer of metal foil, next to a heat sealable polymer layer. The material is next subject to laser drilling to form micro-holes in the seal material. The heat sealable polymer layer of the multi-layer seal material is next placed onto a container filled with product material, and the seal material is heated to bond the seal to the container, thereby forming a product filled container having a breathable seal.

Embodiments of the invention include: the paper or pulp layer having a density of about 200 to 300 grams per square meter; the paper or pulp layer having a thickness of about 0.8 millimeter to about 1.2 millimeters; the layer of polymer being polyethylene; the polyethylene layer having a thickness of about 15 to about 20 microns; the metal foil being aluminum; the aluminum foil having a thickness of about 10 microns to about 25 microns; the adhesive polymer being heat sealable; the adhesive polymer layer having a thickness of about 10 to about 15 microns; the heat sealable polymer being heat sealable polyester, polyvinylidene chloride, polyethylene, polypropylene, or a copolymer of vinyl chloride, vinyl acetate, and maleic acid; the micro-holes being laser drilled; the micro-holes being about 30 to about 50 holes per square inch, i.e., about 0.3 to about 0.6 centimeter apart, and about 0.2 to about 0.6 millimeter in diameter; and the seal material being about 0.8 millimeter to about 1.6 millimeters thick.

Other embodiments include: forming the sealed container by induction heating; the product to be contained being a food; the product being a glucose based powder; the product being a powdered energy drink; and the container being PET, polyethylene, or polypropylene.

These, and additional embodiments, will be apparent from the following descriptions.

### BRIEF DESCRIPTION OF THE DRAWINGS

FIG. 1 shows one layered embodiment of a seal.

FIG. 2 shows a typical perforation pattern in a layered seal.

FIG. 3 shows a typical sealed container embodiment of the present invention.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

Many products, e.g. food and pharmaceutical products, when stored in a sealed container can generate odors which many consider unpleasant. For example, many glucose based powders can give off an alcoholic smell when enclosed in a container that some actually consider putrid. For this reason, products of this type are typically packed in breathable containers or packaging (for example, glucose based powdered energy drinks).

In recent years, for many reasons (e.g., environmental, recycling, weight, cost, etc.), PET (polyethylene terephthalate) jar packaging has become more popular. The combination of the popularity of PET packaging and the need for breathable packaging for many products has presented some special challenges for the packaging industry.

In order to avoid these odors and allow products of this type to be packed in jars, and in particular in PET jars, it is necessary to allow the products to breathe. Typically this is done through the use of paper based seals, paper being favored because of its natural porosity (although, securing these seals onto the lip of the jar has also presented some special challenges as well).

In spite of the benefits the use of paper provides in this environment, the use of these seals comes with significant disadvantages as well. For example, while the paper does have a certain level of natural porosity, it is not totally porous, so only a certain level of generated odors can be managed. In the glucose based products area, for example, only high grades of DMH powders (dextrose mono hydrate, a mono saccharide) can be used in this type of sealed container without the generation and build up of unpleasant odor in the container.

It is also extremely difficult to automate any sealing process utilizing paper seals since the thinness of the paper required for the breathability desired can result in breakage of the paper in the automation process. This can add both time and cost to the packaging process, not only in wasted seals in the supply, but also in terms of adding time to the sealing process, and production of products with defective seals.

Therefore, most processes involving paper seals require manual sealing utilizing heated platens. Paper also typically has a natural inclination to curl. This can cause additional problems on the production line, especially with precut paper seals for manual application. To accommodate automated methods and to overcome the other problems mentioned above, thicker paper has been tried, but this often compromises the breathability of the paper required for it to be effective for this purpose.

Another benefit of constructing the seals as described herein is that the seals can be bonded to the jars by conventional induction heating. This both accelerates the sealing process as compared to other sealing processes, and makes it more conducive to automated processing as well.

Another benefit of the seals constructed as described herein, is that the desired level of breathability in the seal can be customized based on the product being stored in the container. This can be done through perforations generated in the seal because of its ability to allow holes to be formed by conventional laser drilling. This provides the ability to provide the correct amount of breathability specifically dependent on the particular stored product to keep the stored product fresh and odor free.

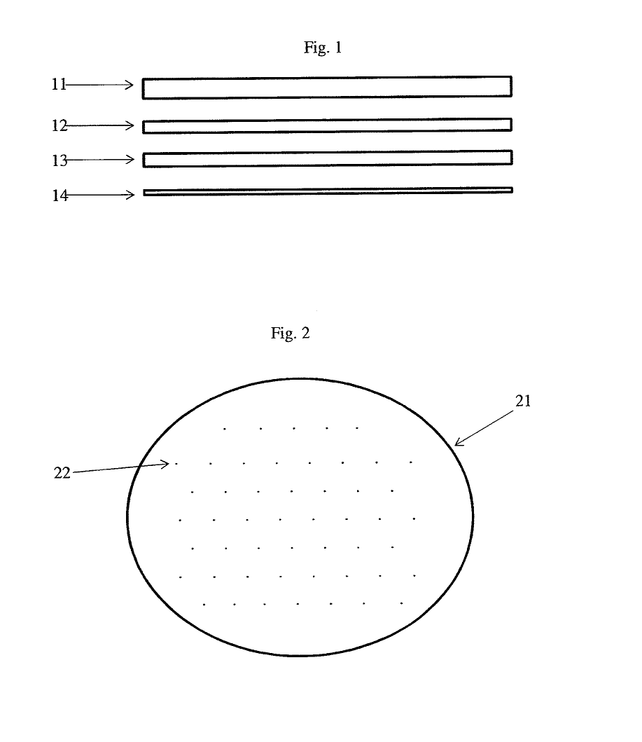

As shown in FIG. 1, the seal is comprises a series of layers. The topmost or outer layer (11) is made up of paper or pulp. This paper or pulp layer is bonded to a metal foil layer (13), e.g., aluminum foil, through a bonding polymer layer (12), e.g., polyethylene. The innermost or bottom layer (14) is made up of a heat sealable polymer layer, e.g., polyvinylidene chloride, polyethylene, or polypropylene.

The bonding layer (12), e.g., polyethylene, as described above, has the function of binding the foil layer to the paper or pulp layer. Polyethlene is particularly desirable with food applications because of its well known common and desirable properties for this use. Other well known polymers with such bonding and adhesive properties can be used as well, either alone or in combinations.

While bonding will typically be effected by heating, especially in an automated version of the process described herein, care must be taken that adhesives and bonding agents, even if known to be food grade, do not generate any unpleasant odors during processing, especially heat processing, which may contaminate or harm the product. And in addition to its bonding properties, this bonding layer also contributes to the desired cushioning described below during transportation of the product.

After securing the above layers together through any conventional or typical lamination operation, the composite seal is then perforated, or made breathable, by drilling micro-holes through the seal with conventional laser drilling apparatus. For example, FIG. 2 shows a typical seal (21) containing the laser drilled holes (22) described herein.

The thickness of the composite layers is important for several reasons. For example, the seal should be thick enough so that it remains intact and does not break in shipping or when the container is dropped accidently, in other words it should be able to take the usual abuse encountered in packing and shipping. The thickness should also be sufficient to provide enough cushion and pressure between the seal and the mouth of the jar, for example, for effective induction sealing to happen. In addition, if the seal material is too thick, the precision in the size and number of holes required as a result of the laser drilling may not be able to be attained.

To provide the proper amount of sealing, coupled with the proper amount of breathability, and the ability to be laser etched, the pulp layer will typically have a density of about 200 to about 300 grams per square meter (gsm), the bonding polymer layer a thickness of about 15 to about 20 microns (μ), the metal foil layer a thickness of about 10 to about 25μ, and the sealable polymer layer a thickness of about 10 to about 15μ.

With the above in mind, the overall seal material is typically about 0.8 millimeters to about 1.6 millimeters thick, and more typically about 1 millimeters to about 1.5 millimeters thick and most typically about 1 millimeters to about 1.3 millimeters thick.

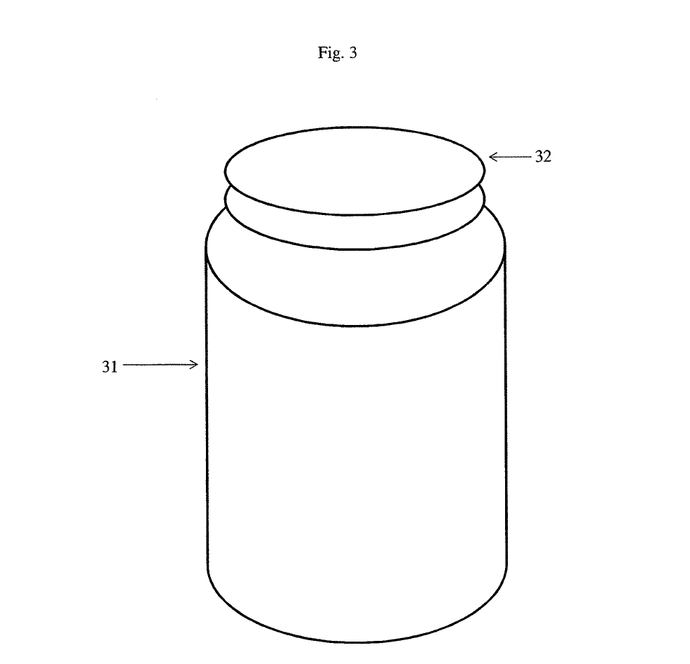

While the seals described herein can be used with any packaging material requiring breathability, they are particularly useful as seals for the mouth openings of jar containers, and particularly plastic jars. And while PET jars are commonly used for packaging, other polymer materials such as polyethylene and polypropylene jars can also be used as well. See FIG. 3, for example, where a typical plastic jar (31) is shown containing a seal as described herein (32) secured to the jar opening.

When using an induction heating process to bond the seal to the container, the sealable layer of material (14) will vary with the material of the container, i.e., need for compatibility. For example, for a PET container it has been found that a polyvinylidene chloride (PVDC) polymer based material works particularly well. In other cases, for example, a polypropylene based polymer layer would be expected to work well with a polypropylene container, a polyethylene based polymer layer with a polyethylene container, etc. In the case of manually applied seals, a layer of a copolymer of vinyl chloride, vinyl acetate, and maleic acid (commercially available VMCH resin, e.g., UCAR resin from Dow Chemical) has been found to work well.

As described above, there are many benefits associated with the use of a seal of the type described herein. One of the more prominent benefits described is the fact that it allows the product to breathe and hence contributes to the elimination of undesirable odors in the stored product, e.g., putrid alcoholic smells associated with glucose containing stored products (for example, allowing energy drinks such as GLUCON D™ (H.J. Heinz) type products to be stored while reducing or eliminating any odor issues). It can also provide evidence that the package has not been tampered with, both from a safety and quality perspective.

The holes are also sized to be open enough to provide breathability to the product, but small enough so that the product does not leak out, and small enough to keep potential ants, bugs and other invading creature from entering the product.

While theoretically other means of forming holes could be used, e.g., needle punching, in practice, especially over time, for any kind of an automated processing, the hole formation would not be precise enough to both provide the desired level of breathability for the particular product, and keep out the unwanted bug etc. invasions mentioned above.

As mentioned above, not only does the seal described herein provide packaging improvements, but it provides improvement in manufacture processing as well. While other paper based breathable seals typically require hand processing, the seals described herein can be applied with automated processing. For example, in one embodiment, the container can optionally come with a screw on or snap on top cap, and in one method of manufacture, the seal can be placed inside the cap and in the induction sealing operation, the seal is released from the cap and becomes attached to the container rim.

For automated processing. the seals are preferably prepared in sheets or rolls which can be attached to the pre-filled containers in an automated processing line, and sealed to the containers with conventional induction sealing apparatus.

Basically, with conventional induction sealing, the metal foil is subjected to a constantly changing induction field. This creates eddy currents on the metal surface, i.e., the free electrons in the metal begin to move in a spiral colliding with other electrons along the way. This creates (controlled) heating in the metal foil. The heating of the metal foil partially melts the polymer layers causing bonding with the packaging material involved, e.g., mouth of the jar (31 in FIG. 3).

As mentioned above, while the seals can be applied manually, an additional benefit is the fact that the seals can be applied in an automated process. Among other things, this can reduce power consumption, reduce line wastage, and improve the productivity of the manufacturing process.

The automated version of the process also reduces the manpower necessary to produce the product, along with the human error issues associated with any manual process. This can be particularly important where there are concerns about hygiene issues related to packaging the product, for example, in the areas of food safety or pharmaceutical packaging. In addition to the environmental benefits described above, there are manufacturing cost benefits which can be realized as well.

### EXAMPLE

A layer of heat sealable polyester film (PET) 12μ thick is laminated to a layer of aluminum foil 12μ thick using conventional bonding adhesives (e.g., conventional two part epoxy resins, cured by conventional heat or UV curing processes, e.g., tunnels). A layer of polyethylene having a density of about 17 gms and 18μ thick is then applied to the aluminum foil, by either conventional heat bonding or extrusion, which is then heat bonded to a pulp layer having a density of 230 gsm and a thickness of 1 millimeter. The seal material is then subjected to laser drilling to form a pattern of holes in the seal material roughly 4 millimeters apart, with hole diameters of about 0.5 millimeter. The seal material is then cut or punch-formed into disks sized to fit on top of a PET jar containing Glucon D. The seal is subjected to induction heating at 60 to 70 Flux at the rate of 100 jars a minute to secure the seal to the jar. After 8 days of shipping and storage, the seal is removed to reveal virtually no product odor.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-30. (canceled)

31. A breathable multi-layer container seal material comprising:
a layer of paper or pulp;
a layer of metal foil;
a polymer bonding layer bonding the layer of paper or pulp to the layer of metal foil;
a layer of adhesive polymer coupled to the layer of metal foil;
a plurality of micro-holes extending between opposite sides of the breathable multi-layer container seal material; and
a thickness of between about 0.8 mm and about 1.6 mm.

32. The seal of claim 31, wherein the paper or pulp layer has a density of about 200 to 300 grams per square meter.

33. The seal of claim 31, wherein the paper or pulp layer has a thickness of about 0.8 to about 1.2 millimeters.

34. The seal of claim 31, wherein the polymer bonding layer is polyethylene.

35. The seal of claim 31, wherein the polymer bonding layer has a thickness of about 15 to about 20 microns.

36. The seal of claim 31, wherein the layer of metal foil is aluminum.

37. The seal of claim 31, wherein the layer of metal foil has a thickness of about 10 microns to about 25 microns.

38. The seal of claim 31, wherein the layer of adhesive polymer is heat sealable.

39. The seal of claim 31, wherein the layer of adhesive polymer has a thickness of about 10 to about 15 microns.

40. The seal of claim 31, wherein the layer of adhesive polymer is heat sealable polyester, polyvinylidene chloride, polyethylene, polypropylene, or a copolymer of vinyl chloride, vinyl acetate, and maleic acid.

41. The seal of claim 31, wherein the micro-holes are laser drilled holes.

42. The seal of claim 31, wherein the micro-holes are between about 0.2 mm to about 0.6 mm in diameter.

43. The seal of claim 42, wherein the micro-holes are spaced apart between about 0.3 to about 0.6 centimeter.

44. A method of making a breathable container seal comprising:
forming the multi-layer breathable seal material of claim 31; and
laser drilling the micro-holes.

45. A sealed container comprising:
a container body; and
a seal coupled to the container body comprising the multi-layer breathable seal material of claim 31.

46. The container of claim 45, wherein the seal is coupled to the container via induction heating.

47. The container of claim 45, wherein the container is one of:
a food product container; and
a container made of PET, polyethylene, or polypropylene.

48. The container of claim 47, wherein the food product container contains one of:
a glucose based powder; and
a powdered energy drink.

49. A breathable multi-layer container seal material comprising:
a layer of paper or pulp;
a layer of metal foil having a thickness of between about 10 and about 25 microns;
a polymer bonding layer bonding the layer of paper or pulp to the layer of metal foil;
said polymer bonding layer having a thickness of between about 15 and about 20 microns;
a layer of adhesive polymer coupled to the layer of metal foil and being structured and arranged to bond the breathable multi-layer container seal material to a container;
a plurality of laser drilled micro-holes extending between opposite sides of the breathable multi-layer container seal.

50. A breathable four layer container seal material comprising:
a layer of paper or pulp;
a layer of metal foil;
a polymer bonding layer bonding the layer of paper or pulp to the layer of metal foil; and
a layer of adhesive polymer coupled to the layer of metal foil and being structured and arranged to bond the breathable four layer container seal material to a container; and
a plurality of micro-holes extending through the breathable four layer multi-layer container seal.
